(19) United States
(12) Patent Application Publication
(10) Pub. No.: US 2013/0115308 A1
(43) Pub. Date: May 9, 2013

(54) DOPED MATERIAL

(71) Applicants: Paul Gannon, Castlebar (IE); Cormac O'Keeffe, Kanturk (IE)

(72) Inventors: Paul Gannon, Castlebar (IE); Cormac O'Keeffe, Kanturk (IE)

(21) Appl. No.: 13/809,226

(22) PCT Filed: Jul. 13, 2011
(86) PCT No.: PCT/EP11/62010

§ 371 Date: Jan. 9, 2013

(30) Foreign Application Priority Data
Jul. 13, 2010 (EP) 10169370.3
Jul. 13, 2010 (IE) 2010/0427

(51) Int. Cl. B01J 27/14; B01J 27/135; B01J 27/02; B01J 21/18; B01J 21/06; B01J 27/00

(52) U.S. Cl. CPC B01J 27/14; B01J 21/063; B01J 27/00; B01J 27/02; B01J 21/18; B01J 27/135
USPC 424/617; 502/350; 502/216; 502/182; 502/227; 502/208; 502/181; 502/185; 502/159; 502/242; 502/60

(57) ABSTRACT

A doped material comprises TiO₂ and three non-metal dopants. The first non-metal dopant comprises sulfur, the second non-metal dopant comprises fluorine, and the third non-metal dopant comprises carbon. The sulfur dopant comprises a cationic dopant, the carbon dopant comprises a cationic dopant, and the fluorine dopant comprises an anionic dopant. The molar ratio of the TiO₂ to the sulfur is approximately 99.75:0.25. The molar ratio of the TiO₂ to the fluorine is approximately 99.1:0.9. The molar ratio of the TiO₂ to the carbon is approximately 98.7:1.3. The material has a transparent, lateral growth crystalline atomic structure. The crystallite particle size is approximately 1 nm. The material is soluble to facilitate dissolving of the material in a solvent without requiring any dispersants to form a true solution.

### INTRODUCTION

This invention relates to a doped material, to a photocatalytic material, and to a method of forming a doped material.

### STATEMENTS OF INVENTION

According to the invention there is provided a doped material comprising

### TiO₂, and

one or more dopants,
at least one of the dopants being a non-metal,
the material being soluble to facilitate dissolving of the material in a solvent to form a solution.

Substantially all of the TiO₂ may be in rutile phase. The metal oxide may comprise TiO₂ with substantially all of the TiO₂ in anatase phase. The metal oxide may comprise TiO₂ with part of the TiO₂ in rutile phase and part of the TiO₂ in anatase phase.

In another embodiment the non-metal dopant is selected from the group comprising sulfur, carbon, nitrogen, phosphorus, fluorine, chlorine, bromine, iodine, selenium, and astatine. The non-metal dopant may comprise an anionic dopant. The non-metal dopant may comprise a cationic dopant. Preferably the material comprises at least two non-metal dopants. Ideally the material comprises at least three non-metal dopants. Most preferably the first non-metal dopant comprises sulfur, the second non-metal dopant comprises fluorine, and the third non-metal dopant comprises carbon.

In one case the molar ratio of the TiO₂ to the non-metal dopant is in the range of from 99.9:0.1 to 97.5:2.5. The non-metal dopant may comprise sulfur, and the molar ratio of the TiO₂ to the non-metal dopant may be in the range of from 99.9:0.1 to 98.5:1.5. Preferably the molar ratio of the TiO₂ to the non-metal dopant is approximately 99.75:0.25. The non-metal dopant may comprise carbon, and the molar ratio of the TiO₂ to the non-metal dopant may be in the range of from 99.5:0.5 to 97.5:2.5. Preferably the molar ratio of the TiO₂ to the non-metal dopant is approximately 98.7:1.3. The non-metal dopant may comprise fluorine, and the molar ratio of the TiO₂ to the non-metal dopant may be in the range of from 99.5:0.5 to 98:2. Preferably the molar ratio of the TiO₂ to the non-metal dopant is approximately 99.1:0.9.

The material may comprise two or more dopants, and at least one of the dopants may be a metal.

The material may be soluble to facilitate dissolving of the material in a polar solvent. In another case the material is soluble to facilitate dissolving of the material in a solvent selected from the group comprising water, acetone, trifluoroacetic acid, ethyl acetate, 3-propanone, glacial acetic acid, tetrahydrofuran, isopropyl alcohol, t-butanol, methoxy-2-propanol, hydroxy-4-methyl-pentanone, and acetic acid. Preferably the material is soluble to facilitate dissolving of the material in a solvent without any dispersants to form a true solution.

In one embodiment the material has a crystalline atomic structure. Preferably the material has a lateral growth crystalline atomic structure. In this manner a smooth and uniform crystal structure may be obtained. Ideally the material has a transparent crystalline atomic structure. Most preferably the crystallite particle size is in the range of from 0.75 nm to 1.75 nm. The small particle size results in a soluble material. The crystallite particle size may be approximately 1 nm.

In another embodiment the material is a photocatalytic material. Preferably the material is photocatalytically active upon activation by visible light. Ideally the material is photocatalytically active upon activation by visible light having a wavelength in the range of from 380 nm to 780 nm. Most preferably the material degrades organic matter upon activation by visible light. In this manner the material is effectively self-cleaning. The material may degrade microbiological matter upon activation by visible light. Preferably the material generates reactive oxygen species upon activation by visible light. Most preferably the material generates hydroxyl radicals and/or superoxide ions upon activation by visible light. Ideally the material reduces the concentration of pollutant gases upon activation by visible light. Most preferably the material reduces the concentration of pollutant gases selected from the group comprising nitrogen oxides, sulphur oxides, carbon oxides, ammonia, volatile organic carbons, and tobacco smoke. The material may inhibit formation of pollutant gases upon activation by visible light. Preferably the material inhibits formation of pollutant gases selected from the group comprising nitrogen oxides, sulphur oxides, carbon oxides, ammonia, volatile organic carbons, and tobacco smoke. Ideally the material becomes superhydrophilic upon activation by visible light. In this manner the material is effectively self-cleaning.

The invention also provides in another aspect a structural component comprising a doped material of the invention.

In one embodiment of the invention the structural component comprises a coating layer, the coating layer comprising a doped material of the invention. Preferably the contact angle defined between a droplet of a liquid resting upon the surface of the coating layer and the surface of the coating layer is less than 25°. Ideally the contact angle is less than 10°. Most preferably the contact angle is less than 5°. In this manner the coating layer is superhydrophilic and effectively self-cleaning.

The structural component may comprise at least part of a tile element, and/or at least part of a steel element, and/or at least part of a polymeric element. The structural component may comprise at least part of a glass element, and/or at least part of a silica element, and/or at least part of a zeolite element. The structural component may comprise grout, and/or paint, and/or cement.

In a further aspect of the invention there is provided a use of a doped material of the invention for coating a surface.

The use of the doped material may be for coating a surface of a tile element, and/or a surface of a steel element, and/or a surface of a polymeric element. The use of the doped material may be for coating a surface of a glass element, and/or a surface of a silica element, and/or a surface of a zeolite element. The use of the doped material may be for grouting a cavity, and/or for painting a surface, and/or as a binding agent.

In one embodiment of the invention the use of the doped material is as a catalyst. Preferably the use of the doped material is as a photocatalyst. Ideally the use of the doped material is for degrading organic matter. In this manner the material is effectively self-cleaning. Most preferably the use of the doped material is for degrading microbiological matter. The use of the doped material may be for reducing the concentration of pollutant gases. The use of the doped material may be for inhibiting formation of pollutant gases.

According to the invention there is provided a photocatalytic material comprising

### TiO₂,

the material being photocatalytically active upon activation by visible light,
the material being soluble to facilitate dissolving of the material in a solvent to form a solution.

Substantially all of the TiO₂ may be in rutile phase. The metal oxide may comprise TiO₂ with substantially all of the TiO₂ in anatase phase. The metal oxide may comprise TiO₂ with part of the TiO₂ in rutile phase and part of the TiO₂ in anatase phase.

In another embodiment the material is photocatalytically active upon activation by visible light having a wavelength in the range of from 380 nm to 780 nm. Preferably the material degrades organic matter upon activation by visible light. In this manner the material is effectively self-cleaning. Ideally the material degrades microbiological matter upon activation by visible light. Most preferably the material generates reactive oxygen species upon activation by visible light. The material may generate hydroxyl radicals and/or superoxide ions upon activation by visible light. Preferably the material reduces the concentration of pollutant gases upon activation by visible light. Ideally the material reduces the concentration of pollutant gases selected from the group comprising nitrogen oxides, sulphur oxides, carbon oxides, ammonia, volatile organic carbons, and tobacco smoke. Most preferably the material inhibits formation of pollutant gases upon activation by visible light. The material may inhibit formation of pollutant gases selected from the group comprising nitrogen oxides, sulphur oxides, carbon oxides, ammonia, volatile organic carbons, and tobacco smoke. Preferably the material becomes superhydrophilic upon activation by visible light. In this manner the material is effectively self-cleaning.

The material may be soluble to facilitate dissolving of the material in a polar solvent. In one case the material is soluble to facilitate dissolving of the material in a solvent selected from the group comprising water, acetone, trifluoroacetic acid, ethyl acetate, 3-propanone, glacial acetic acid, tetrahydrofuran, isopropyl alcohol, t-butanol, methoxy-2-propanol, hydroxy-4-methyl-pentanone, and acetic acid. Preferably the material is soluble to facilitate dissolving of the material in a solvent without any dispersants to form a true solution.

In another case the material has a crystalline atomic structure. Preferably the material has a lateral growth crystalline atomic structure. In this manner a smooth and uniform crystal structure may be obtained. Ideally the material has a transparent crystalline atomic structure. Most preferably the crystallite particle size is in the range of from 0.75 nm to 1.75 nm. The small particle size results in a soluble material. The crystallite particle size may be approximately 1 nm.

In one embodiment the material is doped with one or more dopants. Preferably the dopant is a non-metal and/or a metal. Ideally the non-metal dopant is selected from the group comprising sulfur, carbon, nitrogen, phosphorus, fluorine, chlorine, bromine, iodine, selenium, and astatine. The dopant may comprise an anionic dopant. The dopant may comprise a cationic dopant. Most preferably the material comprises at least two dopants. The material may comprise at least three dopants. Preferably the first dopant comprises sulfur, the second dopant comprises fluorine, and the third dopant comprises carbon.

In another embodiment the molar ratio of the TiO₂ to the dopant is in the range of from 99.9:0.1 to 97.5:2.5. The dopant may comprise sulfur, and the molar ratio of the TiO₂ to the dopant may be in the range of from 99.9:0.1 to 98.5:1.5. Preferably the molar ratio of the TiO₂ to the dopant is approximately 99.75:0.25. The dopant may comprise carbon, and the molar ratio of the TiO₂ to the dopant may be in the range of from 99.5:0.5 to 97.5:2.5. Preferably the molar ratio of the TiO₂ to the dopant is approximately 98.7:1.3. The dopant may comprise fluorine, and the molar ratio of the TiO₂ to the dopant may be in the range of from 99.5:0.5 to 98:2. Preferably the molar ratio of the TiO₂ to the dopant is approximately 99.1:0.9.

The invention also provides in another aspect a structural component comprising a photocatalytic material of the invention.

In one embodiment of the invention the structural component comprises a coating layer, the coating layer comprising a photocatalytic material of the invention. Preferably the contact angle defined between a droplet of a liquid resting upon the surface of the coating layer and the surface of the coating layer is less than 25°. Ideally the contact angle is less than 10°. Most preferably the contact angle is less than 5°. In this manner the coating layer is superhydrophilic and effectively self-cleaning.

The structural component may comprise at least part of a tile element, and/or at least part of a steel element, and/or at least part of a polymeric element. The structural component may comprise at least part of a glass element, and/or at least part of a silica element, and/or at least part of a zeolite element. The structural component may comprise grout, and/or paint, and/or cement.

In a further aspect of the invention there is provided a use of a photocatalytic material of the invention for coating a surface.

The use of the photocatalytic material may be for coating a surface of a tile element, and/or a surface of a steel element, and/or a surface of a polymeric element. The use of the photocatalytic material may be for coating a surface of a glass element, and/or a surface of a silica element, and/or a surface of a zeolite element. The use of the photocatalytic material may be for grouting a cavity, and/or for painting a surface, and/or as a binding agent.

In one embodiment of the invention the use of the photocatalytic material is as a catalyst. Preferably the use of the photocatalytic material is as a photocatalyst. Ideally the use of the photocatalytic material is for degrading organic matter. In this manner the material is effectively self-cleaning. Most preferably the use of the photocatalytic material is for degrading microbiological matter. The use of the photocatalytic material may be for reducing the concentration of pollutant gases. The use of the photocatalytic material may be for inhibiting formation of pollutant gases.

According to the invention there is provided a method of forming a doped material, the method comprising the steps of

adding a non-metal dopant to TiO₂ to form a doped product, and
annealing the doped product.

By annealing the doped product, multi-doping of the TiO₂ may be achieved.

In one embodiment of the invention the method comprises the step of forming the TiO₂ before adding the non-metal dopant. Preferably the step of forming the TiO₂ comprises the step of hydrolysis of a metal compound. Ideally the step of hydrolysis of the metal compound comprises the step of adding the metal compound to an alcohol to form an hydrolysis product. Most preferably the step of forming the TiO₂ comprises the step of neutralisaton of the hydrolysis product. The step of neutralisaton of the hydrolysis product may comprise the step of adding the hydrolysis product to an alkali to form a neutralisation product. Preferably the step of forming the TiO₂ comprises the step of washing the neutralisation product. Ideally the step of forming the TiO₂ comprises the step of drying the neutralisation product to form hydrous TiO₂.

In one case the method comprises the step of solubilising the TiO₂ before adding the non-metal dopant. Preferably the TiO₂ is solubilised by adding the TiO₂ to an organic acid. The organic acid may provide one or more additional dopants to achieve multi-doping of the TiO₂ after annealing the doped product. Ideally the organic acid is selected from the group comprising trifluoroacetic acid, trichloroacetic acid, tribromoroactic acid, triiodoacetic acid, cyanoacetic acid, formic acid, acetic acid, propanoic acid, butanoic acid, fluoroacetic acid, difluoroacetic acid, fluorinated formic acid, fluorinated propanoic acid, fluorinated butanoic acid, chloroacetic acid, dichloroacetic acid, chlorinated formic acid, chlorinated propanoic acid, chlorinated butanoic acid, bromoacetic acetic acid, dibromoacetic acid, brominated formic acid, brominated propanoic acid, brominated butanoic acid, iodoacetic acetic acid, diiodomoacetic acid, and iodinated formic acid. By selecting the appropriate organic acid, the one or more additional dopants may be determined. Most preferably the method comprises the step of refluxing the mixture of the TiO₂ and the organic acid.

The non-metal dopant may be added to the TiO₂ before annealing the doped product. Preferably the non-metal dopant is added in powder form to the TiO₂. The non-metal dopant may be added to the TiO₂ during the step of annealing the doped product. Preferably the method comprises the step of adding a metal dopant to the TiO₂. Ideally the metal dopant is added to the TiO₂ before annealing the doped product. Most preferably the non-metal dopant is selected from the group comprising sulfur, carbon, nitrogen, phosphorus, fluorine, chlorine, bromine, iodine, selenium, and astatine. At least two non-metal dopants may be added to the TiO₂. Preferably at least three non-metal dopants are added to the TiO₂. Ideally the first non-metal dopant comprises sulfur, the second non-metal dopant comprises fluorine, and the third non-metal dopant comprises carbon.

In one embodiment the method comprises the step of refluxing the doped product before annealing.

In another embodiment the method comprises the step of applying the doped product to a surface before annealing. The annealing may result in a secure bond between the doped product and the surface. The doped product may be applied to the surface by dip coating. The doped product may be applied to the surface by spray coating. The doped product may be applied to the surface by spin coating.

In one case the doped product is annealed at a temperature in the range of from 500° C. to 1000° C. Preferably the doped product is annealed at a temperature of approximately 600° C.

Substantially all of the TiO₂ may be in rutile phase after annealing. The metal oxide may comprise TiO₂ with substantially all of the TiO₂ in anatase phase after annealing. The metal oxide may comprise TiO₂ with part of the TiO₂ in rutile phase and part of the TiO₂ in anatase phase after annealing. The non-metal dopant may comprise an anionic dopant after annealing. The non-metal dopant may comprise a cationic dopant after annealing.

The invention also provides in another aspect a process of producing a multi-doped crystal structure with cationic and anionic dopants comprising the step of annealing between a temperature range of 500° C. to 1000° C.

### BRIEF DESCRIPTION OF THE DRAWINGS

The invention will be more clearly understood from the following description of an embodiment thereof, given by way of example only, with reference to the accompanying drawings, in which:

FIG. 1 is a schematic illustration of the photoreductive mechanism of resazurin dye,

FIG. 2 is a table of results of Escherichia coli survival testing,

FIG. 3 is a graph of results of Escherichia coli survival testing,

FIG. 4 is a graph of the calibration of response versus NO₂ concentration,

FIG. 5 is a schematic illustration of the difference between hydrophilic and hydrophobic surfaces,

FIG. 6 is a schematic illustration of a superhydrophilic surface with increased hydrogen bonding,

FIG. 7 is a photograph illustrating the superhydrophilicty of multi-doped TiO₂ coated tiles,

FIG. 8(a) is a graph of infrared spectrum of a washed and dried hydrous TiO₂,

FIG. 8(b) is a graph of x-ray diffraction pattern of a washed and dried hydrous TiO₂,

FIG. 9(a) is a graph of infrared spectrum of solubilised TiO₂,

FIG. 9(b) is a graph of x-ray diffraction pattern of solubilised TiO₂,

FIG. 10 is a schematic illustration of a sulfur doping mechanism,

FIG. 11(a) is a graph of infrared spectrum of sulfur doped TiO₂,

FIG. 11(b) is a graph of x-ray diffraction pattern of sulfur doped TiO₂,

FIG. 12(a) is a graph of x-ray photoelectron spectroscopy spectrum of sulfur in a multi-doped TiO₂ film,

FIG. 12(b) is a graph of x-ray photoelectron spectroscopy spectrum of fluorine in a multi-doped TiO₂ film,

FIG. 12(c) is a graph of x-ray photoelectron spectroscopy spectrum of carbon in a multi-doped TiO₂ film,

FIG. 13 is a graph of x-ray diffraction pattern of sulfur doped TiO₂ film applied to a ceramic tile and a sulfur doped TiO₂ powder,

FIG. 14 is a schematic illustration of the photoresponse of TiO₂ by visible light,

FIG. 15 is a graph of x-ray diffraction pattern of multidoped TiO₂ material,

FIG. 16(a) is a photograph of a material according to the invention,

FIG. 16(b) is a photograph of another material,

FIG. 17 is a schematic illustration of a sulfur doping mechanism,

FIG. 18 illustrates multi-doping of TiO₂,

FIG. 19 is a schematic illustration of photoexcitation of an electron,

FIG. 20 is a schematic illustration of generation of reactive oxygen species,

FIG. 21 is a schematic illustration of a contact angle of a droplet,

FIG. 22 is an Atomic Force Microscopy (AFM) image of a coated tile and an uncoated tile,

FIG. 23 is a graph of zeta potential distribution of a material according to the invention in acetone, and

FIG. 24 is a graph of zeta potential distribution of a material according to the invention in isopropyl alcohol.

### DETAILED DESCRIPTION

Referring to the drawings, there is disclosed herein a doped photocatalytic material according to the invention, and a method of forming a doped photocatalytic material according to the invention.

The material comprises TiO₂ and one or more dopants.

Substantially all of the TiO₂ is in rutile phase. The metal oxide may alternatively comprise TiO₂ with substantially all of the TiO₂ in anatase phase. The metal oxide may alternatively comprise TiO₂ with part of the TiO₂ in rutile phase and part of the TiO₂ in anatase phase.

In this case the material comprises three dopants, each dopant being a non-metal. Each non-metal dopant may be selected from the group comprising sulfur, carbon, nitrogen, phosphorus, fluorine, chlorine, bromine, iodine, selenium, and astatine. In one example the first non-metal dopant comprises sulfur, the second non-metal dopant comprises fluorine, and the third non-metal dopant comprises carbon. The invention enables multi-doping of TiO₂ with three or more dopants. In this case there is multi-doping of TiO₂ with sulfur, fluorine and carbon. The sulfur dopant comprises a cationic dopant, the carbon dopant comprises a cationic dopant, and the fluorine dopant comprises an anionic dopant.

The molar ratio of the TiO₂ to each non-metal dopant is in the range of from 99.9:0.1 to 97.5:2.5. The molar ratio of the TiO₂ to the sulfur is in the range of from 99.9:0.1 to 98.5:1.5. In one example the molar ratio of the TiO₂ to the sulfur is approximately 99.75:0.25. The molar ratio of the TiO₂ to the fluorine is in the range of from 99.5:0.5 to 98:2. In one example the molar ratio of the TiO₂ to the fluorine is approximately 99.1:0.9. The molar ratio of the TiO₂ to the carbon is in the range of from 99.5:0.5 to 97.5:2.5. In one example the molar ratio of the TiO₂ to the carbon is approximately 98.7:1.3.

The material has a transparent, lateral growth crystalline atomic structure. The crystallite particle size is in the range of from 0.75 nm to 1.75 nm. In one example the crystallite particle size is approximately 1 nm. The lateral film growth of the sulfur doped TiO₂ aids in the smoothness and transparency of coating layers or films comprising the material, and thus maintains the aesthetic quality of an underlying surface or substrate upon which the coating layer or film is applied.

The material is soluble to facilitate dissolving of the material in a polar solvent without requiring any dispersants to form a true solution. In this case the material is soluble to facilitate dissolving of the material in a solvent selected from the group comprising water, acetone, trifluoroacetic acid, ethyl acetate, 3-propanone, glacial acetic acid, tetrahydrofuran, isopropyl alcohol, t-butanol, methoxy-2-propanol, hydroxy-4-methyl-pentanone, and acetic acid. Because of the small particle size, the material may form a true solution, and smooth, uniform films of multi-doped TiO₂ may be produced. In particular the material does not produce a colloidal solution in which TiO₂ is divided into particles and dispersed throughout a liquid. In a colloidal solution large particles remain suspended in the liquid due to charge interactions or by the addition of additives such as dispersants. The particles are much larger than those found in true solutions. The size of colloidal particles may be as large as for example 1000 nm.

The process of the invention produces truely soluble S-doped TiO₂ resulting in a homogenous solution of TiO₂ in common solvents without the need for additives such as dispersants for stability. The solubility of the TiO₂ is dictated by its ability to dissolve in another compound, in this case a molecular liquid. TiO₂ produced by the invention has the ability to fully dissolve in common solvents.

Doping does not affect the solubility of the material. The dopant is added in elemental form which does not remove the coordinated organic layer from the particle. The coordinated organic layer is the layer that gives the material solubility.

The material is photocatalytically active upon activation by visible light having a wavelength in the range of from 380 nm to 780 nm. The material absorbs visible light which causes activation of the material for the full life of the material. The photocatalytic activity of the material may have a number of forms. The photocatalytic functionality of the sulfur doped TiO₂ film material may include photocatalytic degradation of matter and photocatalytic induced hydrophilicity.

In relation to photocatalytic degradation of matter, the material may generate reactive oxygen species, such as hydroxyl radicals and/or superoxide ions, upon activation by visible light. The reactive oxygen species degrade organic matter, such as microbiological matter. Because of the antimicrobial activity of the material, the material and a surface to which the material is applied may thus be easier to clean. An application for the multi-doped TiO₂ material is as a biocide.

The material may reduce the concentration of pollutant gases, such as nitrogen oxides, sulphur oxides, carbon oxides, ammonia, volatile organic carbons, and tobacco smoke, upon activation by visible light. The material may inhibit formation of pollutant gases, such as nitrogen oxides, sulphur oxides, carbon oxides, ammonia, volatile organic carbons, and tobacco smoke, upon activation by visible light. The material may thus be used as an anti-odour and pollution control means for nitrogen oxides and sulphur oxides. An application for the multi-doped TiO₂ material is as an antipollution measure.

The material of the invention may be employed to reduce the concentration of pollutant gases. In particular the degradation of NO₂, or more generally of NOx, is referred to as denitrogenization. This denitrogenization process may be described as a reaction on the surface of the activated TiO₂ particle with the reactive oxygen species .OH:

NO₂+.OH→NO₃⁻+H⁺

The free hydroxyl radical .OH is generated on the TiO₂ surface by migration of a hole in the valence band in combination with the presence of water. The .OH acts as a strong oxidant and oxidises NO₂ to the nitrate ion NO₃⁻ which may be flushed from the surface as weak nitric acid. This reaction describes the photocatalytic process on the surface of the TiO₂ film.

The material of the invention may be employed to inhibit the formation of pollutant gases. In particular in a pollution rich environment UV solar radiation breaks down volatile hydrocarbons through a photochemical cycle. This triggers a series of chain reactions that result in the formation of peroxide radicals (RO₂). RO₂ radicals oxidise nitrogen monoxide producing NO₂. Each RO₂ radical catalyses the conversion of many NO molecules to NO₂ before finally extinguishing. The generated NO₂ will then go through photolysis to produce ozone, re-generating an NO molecule that becomes available for a new oxidation process. However, removal of NO₂ from the environment through reaction with .OH, producing nitric acid, removes NO₂ from the photochemical cycle inhibiting the formation of further pollutant gases.

Battery testing of a wide range of dopants was examined and testing was carried out using ultraviolet light. Ultraviolet light was chosen for the testing due to the speed of generated results from a large number of coated samples in comparison to visible light testing.

### Example 1

### Ultraviolet Light Resazurin Dye Testing of the Doped TiO₂ Films

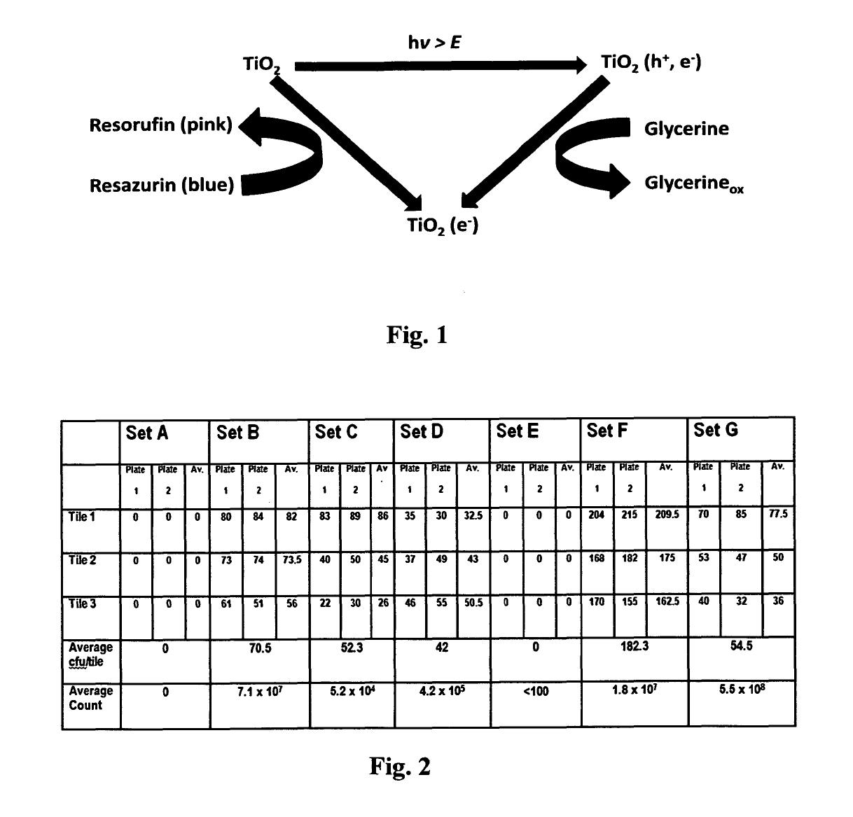

The photocatalytic ability of the deposited doped TiO₂ films was examined using UV lamps, 254 nm and 365 nm, to activate the films. The redox dye resazurin was used as the surrogate for testing. Resazurin was chosen for its photoreductive conversion to resorufin giving a dramatic blue to pink colour as illustrated in FIG. 1. FIG. 1 illustrates the photoreductive mechanism of resazurin dye. The substrate for the UV light testing was glass coupons. Nine dopants were tested: antimony, aluminum, copper, iron, niobium, nitrogen, silver, sulfur and vanadium, as well as undoped TiO₂. The best performing of these were sulfur and nitrogen doped TiO₂ films.

### Example 2

### Visible Light Resazurin Dye Testing of Doped TiO₂ Films

Upon review of the UV resazurin dye results of Example 1, a number of the best performing films including N, S and Ag-doped TiO₂, as well as carbon doped TiO₂ were used in the next stage of testing. This next set of testing was used to evaluate the photoreductive ability of the films using visible light from a fluorescent light source. The substrate for this testing was ceramic tiles. Ceramic tiles were picked as the testing substrate due to the high annealing temperatures needed.

Following testing to optimize and investigate the nature of the films, multi-doped sulphur, fluorine and carbon doped TiO₂ films were considered to be the best performing, most economical and easiest to produce.

The apparent increase in visible light photocatalytic ability may be explained by the doping of the TiO₂ lattice with sulfur, nitrogen, carbon, fluorine or silver. The introduction of a dopant in this case reduces the band gap allowing easier promotion of electrons from the valance shell to the conduction band. This reduction in the band gap is brought about by moving the wavelength that TiO₂ can absorb electromagnetic energy, that is moving its absorbance into the visible light spectrum.

### Example 3

### Visible Light Microbiological Testing of Multi-Doped TiO₂ Films

TiO₂ is a photocatalyst which absorbs ultraviolet radiation from sunlight or an illuminated light source and in the presence of water vapour produces hydroxyl radicals and superoxide ions. The hydroxyl radicals are strong oxidisers and attack many organic materials causing cell damage and death. A ceramic tile coated with TiO₂ and exposed to a light source shows a decrease in a bacterial load when compared to an uncoated ceramic tile or even a TiO₂ coated ceramic tile unexposed to a light source.

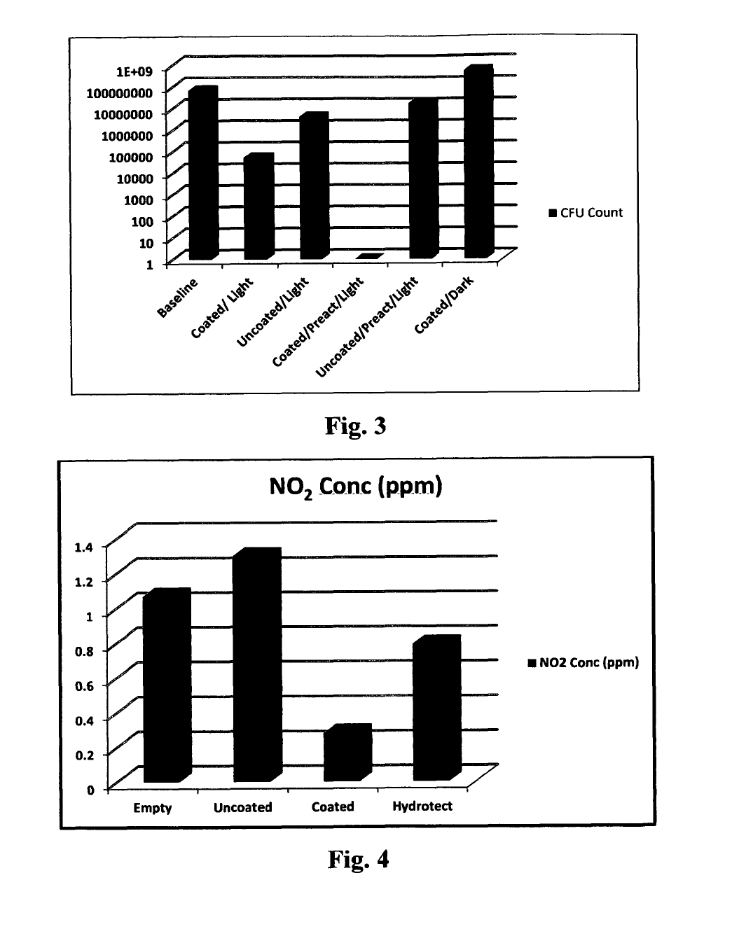

The next set of testing carried out on the TiO₂ films were microbiological survival trials with multi-doped TiO₂ films. Coated ceramic tile samples were provided and testing conditions carried out under a desktop fluorescent lamp. The results were positive in relation to the films ability to absorb visible light, generate reactive oxygen species (ROSs) which subsequently kill bacteria for Staphylococcus aureus and Escherichia coli. Results of the Escherichia coli survival testing are illustrated in FIGS. 2 and 3 where:

Set A: Sterility control

### Set B: Baseline

Set C: Coated sample with light
Set D: Uncoated sample with light
Set E: Coated sample with preactivation and light
Set F: Uncoated sample with preactivation and light
Set G: Coated sample in darkness

### Example 4

### Visible Light NO₂ Gas Detection Testing

The target pollutant gas selected for detection was NO₂, which is a common pollutant gas found in the environment. NO₂ may be more harmful than CO₂ and may cause eye irritation, respiratory illness, arterial sclerosis and may be carcinogenic.

The testing evaluated the reduction of NO₂ concentration in a reaction vessel, with a controlled environment, by the presence of a coated sample of the material of the invention, a sample of another tile, and an uncoated tile using a desktop fluorescent lamp as the light source. These results were compared to an empty vessel as the baseline. FIG. 4 illustrates the calibration of response versus NO₂ concentration.

The presence of the coated tiles of the invention resulted in a 73% drop in NO₂ concentration in comparison to the empty vessel. The other tile samples caused a 26% drop in NO₂ concentration meaning the coated tiles of the invention is 280% more efficient at the removal of NO₂ from the environment than the other tile samples.

The coated tiles of the invention may also eliminate other atmospheric pollutants such as volatile organic carbons (VOC), ammonia and tobacco smoke. The removal of these unwelcome and damaging odours and the inhibition of their formation may have a particular application for sanitary, kitchen and common areas.

In relation to the photocatalytic induced hydrophilicity, the material may become superhydrophilic upon activation by visible light. In particular in the case where a coating layer comprising the material is applied to a structural component, the contact angle defined between a droplet of a liquid resting upon the surface of the coating layer and the surface of the coating layer may be less than 25°, and in this case is less than 5°. Because of the hydrophilic nature of the material, the material and a surface to which the material is applied may thus be easier to clean.

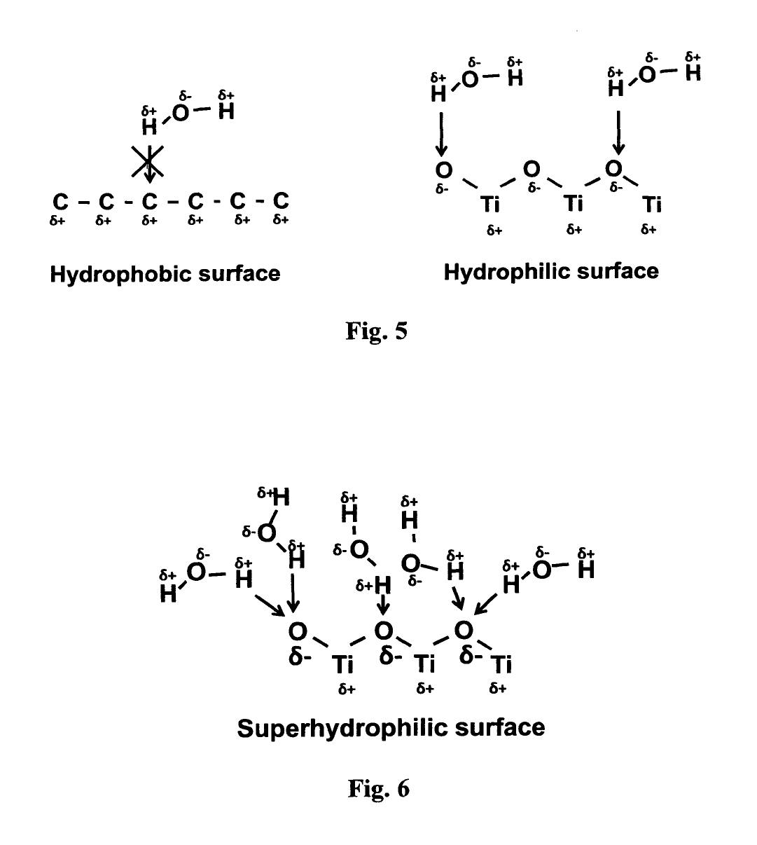

Untreated surfaces such as ceramic tiles may have a hydrophobic surface which repels water forming droplets. Contaminated liquids that come in contact with ceramic surfaces form droplets, which over time evaporate leaving dirt remaining behind on the tile surface. Hydrophilic surfaces made with TiO₂ attract water to the surface through hydrogen bonding as illustrated in FIG. 5. FIG. 5 illustrates the difference between hydrophilic and hydrophobic surfaces. Films produced by the sulfur doped TiO₂ due to the higher activity and improved charge generation lead to ‘superhydrophilic’ surfaces. This causes a greater attraction with water as illustrated in FIG. 6 due to increased hydrogen bonding. The water lies flat on the surface in sheets instead of forming droplets. Dirt particles on the surface are picked up by the water and washed down in the sheet of water.

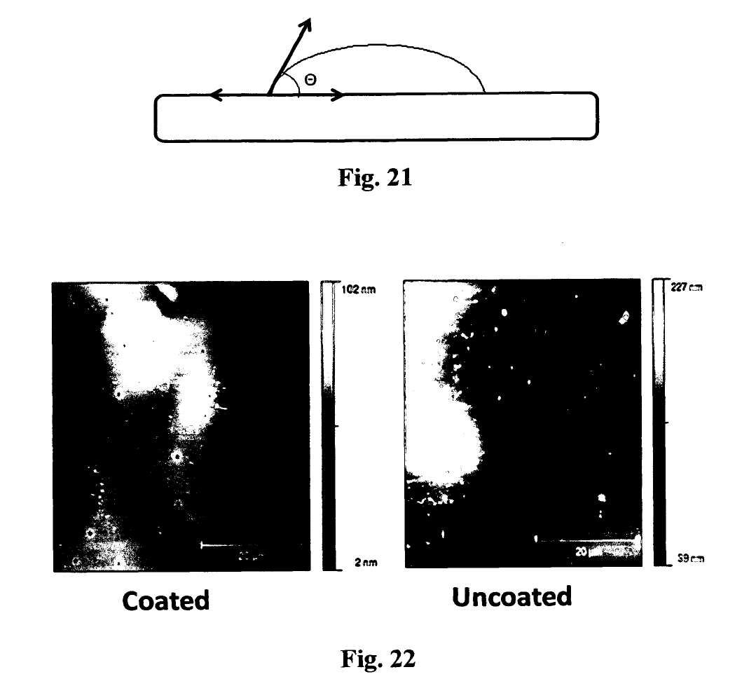

The contact angle is the angle at which a liquid meets a solid surface, as illustrated in FIG. 21. If the liquid is attracted to the surface the droplet will spread out on the surface. This produces a small contact angle. If water has a small contact angle with a surface, the surface is said to be hydrophilic. If the water has a large contact angle, the surface is said to be hydrophobic. FIG. 21 illustrates the contact angle of a droplet.

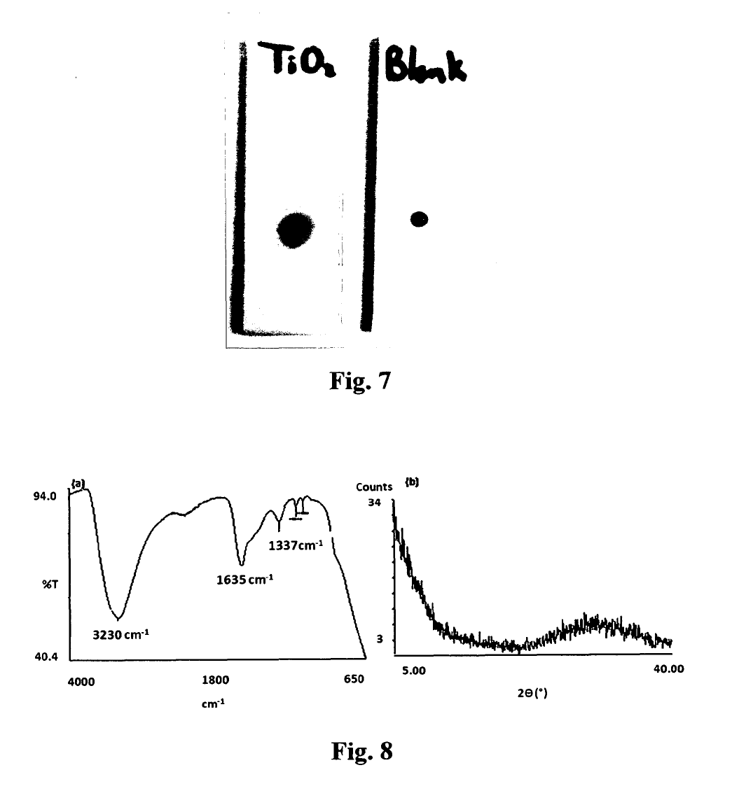

Measuring the contact angle between the water droplet and the surface reveals the hydrophilicity of the surface, as illustrated in FIG. 7. Untreated ceramic tiles are hydrophobic and may have an average contact angle of 46°. Other TiO₂ coated tiles may produce contact angles of 25° while films produced by the sulfur doped TiO₂ of the invention may have contact angles as low as 2° to 4°. FIG. 7 illustrates the superhydrophilicty of the sulfur doped TiO₂ coated tiles.

A goniometer instrument may be used to measure the contact angle, which uses cameras and software to capture and analyze the drop shape. Multi-doped TiO₂ films of the invention, due to their higher activity and improved charge generation, lead to ‘superhydrophilic’ surfaces, as illustrated in FIG. 7. FIG. 7 illustrates the superhydrophilicty of multidoped TiO₂ coated tiles.

The invention uses practical repeatable testing, for example antibacterial, antipollution, and contact angle, to test the efficiency of the invention.

The production of the soluble doped titanium dioxide material may involve a six step process:

### Step 1: Hydrolysis

### Step 2: Neutralisation

### Step 3: Washing and Drying

### Step 4: Solubilising

### Step 5: Doping

### Step 6: Annealing

Steps 1-3 are involved in the formation of hydrous TiO₂. The first two steps of the process play a role in determining the size of the particle produced. If poor heat regulation is employed during the Hydrolysis and Neutralisation steps the hydrous TiO₂ may not dissolve during the Solubilising step. This is due to the particle size growing beyond a critical point. Steps 4 and 5 involve non-metal doping. Step 6 of the process is responsible for the generation and adhesion of the film to a substrate as well as multi-doping of both cationic and anionic species in to the TiO₂ lattice.

To form the doped photocatalytic material, the TiO₂ is formed initially before adding the non-metal dopants. The TiO₂ is formed by hydrolysis of a metal compound. In particular the metal compound is added to an alcohol to form an hydrolysis product. Step 1 involves the reaction of TiCl₄ (titanium tetrachloride) in the alcohol which may be isopropyl alcohol to produce Ti(OPr)₄ (titanium isopropoxide) and HCl (hydrochloric acid) or collectively called the hydrolysis product (HP) in an ice bath, see equation 1.

TiCl₄+HOPr→Ti(OPr)₄+4HCl Equation 1:

The addition of the TiCl₄ to the alcohol reduces the exothermic nature of the reaction in comparison to H₂O, rendering it more industrially friendly as well as helping to maintain a small particle size.

The hydrolysis product is neutralised by adding the hydrolysis product to an alkali to form a neutralisation product. Step 2 involves the reaction of the HP with NaOH (sodium hydroxide) until a pH of 6-6.2 is achieved to produce hydrous TiO₂ (TiO₂.H₂O), NaCl (sodium chloride) and H₂O (water) or collectively called the neutralisation product (NP), see equation 2. The reaction is again carried out in an ice bath to maintain a small particle size.

Ti(OPr)₄+HCl+NaOH→TiO₂.H₂O+4NaCl+H₂O Equation 2:

The neutralisation product is washed, and the neutralisation product is dried to form a hydrous TiO₂. In Step 3 the large amount of NaCl by-product produced during the neutralisation step is removed. An extensive washing process using deionised H₂O is conducted to reduce the NaCl content to between 200 p.p.m. and 600 p.p.m. The washed hydrous TiO₂ is then dried.

The hydrous TiO₂ at the end of this step may be analysed using infrared (IR) and x-ray diffraction (XRD). FIG. 8(a) illustrates the IR spectrum and FIG. 8(b) illustrates the XRD pattern of the washed and dried hydrous TiO₂. The IR spectrum (FIG. 8(a)) reveals the characteristic O—H stretch giving a broad peak at 3230 cm⁻¹ and a H—O—H bend at 1635 cm⁻¹ from both coordinated and uncoordinated H₂O confirming the TiO₂ is hydrous in nature. The XRD pattern (FIG. 8(b)) reveals anatase to be the dominant phase of TiO₂ present with a broad bend observed in the 2Θ-region of 20-40°.

The TiO₂ is solubilised before adding the non-metal dopants by adding the TiO₂ to an organic acid. The organic acid may be selected from the group comprising trifluoroacetic acid, trichloroacetic acid, tribromoroactic acid, triiodoacetic acid, cyanoacetic acid, formic acid, acetic acid, propanoic acid, butanoic acid, fluoroacetic acid, difluoroacetic acid, fluorinated formic acid, fluorinated propanoic acid, fluorinated butanoic acid, chloroacetic acid, dichloroacetic acid, chlorinated formic acid, chlorinated propanoic acid, chlorinated butanoic acid, bromoacetic acetic acid, dibromoacetic acid, brominated formic acid, brominated propanoic acid, brominated butanoic acid, iodoacetic acetic acid, diiodomoacetic acid, and iodinated formic acid. In this case the organic acid comprises trifluoroacetic acid. Step 4 involves the solubilising of the dried hydrous TiO₂ in TFA (trifluoroacetic acid), see equation 3. During this step the trifluoroacetic acid molecules coordinate to the surface of the TiO₂ particle displacing H₂O rendering the TiO₂ soluble.

TiO₂.H₂O+TFA→TiO₂/TFA+H₂O Equation 3:

The mixture of the TiO₂ and the organic acid are refluxed. The TiO₂ is first refluxed in the TFA until fully dissolved; excess TFA is then removed leaving the soluble TiO₂/TFA material.

There are two important parameters for solubilising in this step: the dryness of the hydrous TiO₂—a correct level of coordinated H₂O to TiO₂ particle is critical; and the particle size—the smaller the particle size of the hydrous TiO₂ the easier to solubilise the material.

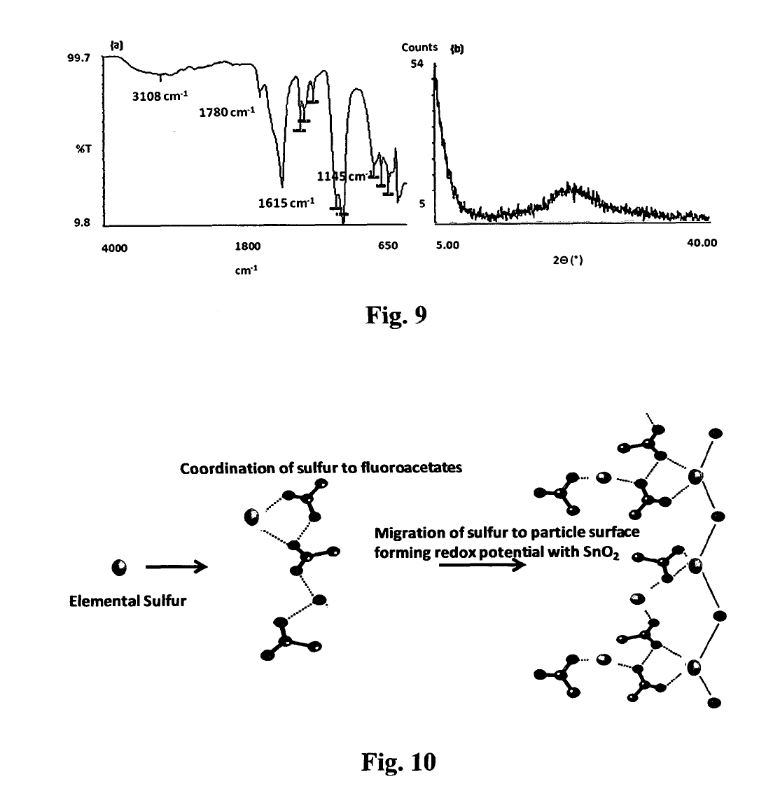

FIG. 9(a) illustrates the IR spectrum and FIG. 9(b) illustrates the XRD pattern of the solubilised TiO₂. The IR spectrum (FIG. 9(a)) reveals the characteristic trifluoroacetate peaks illustrating their surface bound coordinated nature. The XRD pattern (FIG. 9(b)) reveals the TiO₂ crystal phase of anatase is retained with a slight sharpening of the band due to the crystal growth during the solubilising at 80° C.

The solubilising process of the TiO₂ is possible because of the small particle size for example 1 nm. During solubilising of the TiO₂, sufficient organic molecules are attached to the particle and this new organic constituent of the particle enables it to be then soluble in common solvents. Large agglomerated particles would not be solubilised by an organic acid. For larger particles the coordination sites for the organic acids are reduced and the decrease in organic content reduces solubility.

The three non-metal dopants are added in powder form to the refluxed mixture of the TiO₂ and the organic acid to form a doped product before annealing the doped product. In this case the first non-metal dopant comprises sulfur, the second non-metal dopant comprises fluorine, and the third non-metal dopant comprises carbon. Step 5 involves the doping of the soluble TiO₂/TFA with the non-metal, such as sulfur, see equation 4. The soluble TiO₂/TFA is first dissolved in acetone and elemental sulfur powder is added.

TiO₂/TFA+S→S/TiO₂/TFA Equation 4:

The doped product is refluxed before annealing. The mixture is refluxed for 3-4 hours and then isolated.

The doping process occurs because the trifluoroacetate groups coordinated to the TiO₂ particle act as secondary coordination species coordinating to the sulfur as illustrated in FIG. 10. The sulfur migrates to the surface of the TiO₂ particle where the redox potential generated introduces or dopes the sulfur into the TiO₂ crystal lattice. Any remaining surface coordinated sulfur will be doped into the TiO₂ crystal lattice during the annealing process at a temperature of from 500° C. to 1000° C. utilising the energy from the elevated temperature. FIG. 10 illustrates the sulfur doping mechanism.

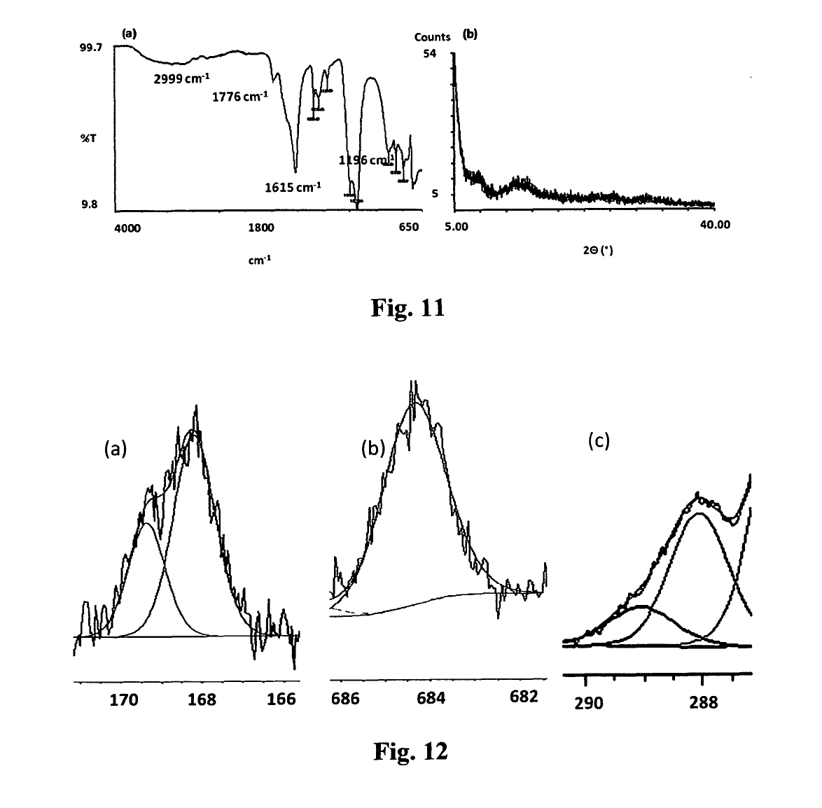

FIG. 11(a) illustrates the IR spectrum and FIG. 11(b) illustrates the XRD pattern of the sulfur doped TiO₂/TFA. The IR spectrum (FIG. 11(a)) confirms that the trifluoroacetate groups are still coordinated after the doping process indicating the sulfur doping did not affect the trifluoroacetate content of the TiO₂ particles. The XRD pattern (FIG. 11(b)) also reveals the anatase TiO₂ crystal structure remains unchanged during the doping process.

The doped product is applied to a surface such as a surface of a ceramic tile element, or a steel element, or a polymeric element, or a glass element, or a silica element, or a zeolite element by any suitable method, for example dip coating, or spray coating, or spin coating, before annealing. The method of deposition may use dip, spray or spin coating techniques. These techniques are relatively easy to use and relatively inexpensive.

The following procedure may be employed for dip coating:

Clean, dry and dust free substrates are inspected and prepared for dip coating. The solution for deposition is poured into a glass beaker and placed on a dip coating rig. The controls of the dip coating rig are set to the required immersion speed, dwell time and withdrawal speed. The substrate is gently clamped into the dip coating machine and ensuring that the trailing edge of the substrate is totally horizontal to minimize non-uniform deposition of the film. The coated substrate is unclamped and left to dry with an uncoated edge leaning against a block. The substrates are allowed to dry for 1-2 hours. The dry substrates are placed uniformly on a wrought iron frame and placed in a furnace. The substrates are heated to the required temperature, with a rate of heating of 10° C. per minute, and maintained for one hour.

The following procedure may be employed for spray coating:

Clean, dry and dust free (100 mm×100 mm) ceramic substrates are inspected and prepared for spray coating, the substrate is held vertically in place in a fumehood. The spray solution for deposition is poured into the reservoir of the spray gun and the spray gun is connected up to a 2HP Fox model air compressor. The air compressor is switched on and the air pressure is allowed to build to 1 MPa and a working pressure of 0.8 MPa-1 MPa is maintained during coating. The volume and type of spray are adjusted to the desired level; spray coating is at all times carried out in a vented fumehood. The substrate may be spray coated by a single pass or with multiple passes of the spray gun. The coated substrate is unclamped and left to dry with an uncoated edge leaning against a block. The substrates are allowed to dry for 1-2 hours. The dry substrates are placed uniformly on a wrought iron frame and placed in a furnace. The substrates are heated to the required temperature, with a rate of heating of 10° C. per minute, and maintained for one hour.

The following procedure may be employed for spin coating:

Clean, dry and dust free (10 mm×10 mm) silica coated glass coupons are inspected and prepared for spin coating. Samples were placed in a Chemat spin coater. 0.3 cm³ of the coating solution is dropped from a pipette an inch above the glass coupon while the coupon is rotating at 300 rpm. This rotation is maintained for 10 seconds before a second rotation of 2000 rpm for 30 seconds is carried out. The coated substrate is then removed and left to dry in a dust free environment for 24 hours. The dry substrates are placed uniformly on a wrought iron frame and placed in a furnace. The substrates are heated to the required temperature, with a rate of heating of 10° C. per minute, and maintained for one hour.

Deposition of the sulfur doped TiO₂ material on to the substrates may be carried out by dip coating, or spin coating, or spray coating, or roller coating, or flow coating. The material may be deposited on ceramic tiles, or glass, or stainless steel.

The doped product applied to the surface is then annealed at a temperature in the range of from 500° C. to 1000° C. In this case the doped product is annealed at a temperature of approximately 600° C. Step 6 involves the deposition of the sulfur doped TiO₂/TFA on to a substrate surface, for example a ceramic tile and annealing of the material on to that surface. Deposition may be carried out using tradition sol-gel techniques such as dip, spray, spin coating. Annealing may be performed in a conventional furnace oven between temperatures of 500° C. and 1000° C.

During annealing the heating process sinters the particles together to form a homogenous film as well as bonding the film to the substrate surface forming a durable chemically resistance film. Annealing also leads to multi-doping of the already sulfur doped TiO₂. This is due to the thermal decomposition of the surface trifluoroacetate groups and migration of carbon and fluorine atoms into the TiO₂ lattice.

Non-metal dopants such as sulfur, nitrogen and phosphorus may be selectively added to the TiO₂ in the doping step of the manufacturing process. Nitrogen may be added by means of a nitrogen containing ligand. Non-metal dopants such as carbon, fluorine, chlorine, bromine and iodine may be automatically added to the TiO₂ integrated as dopants into the TiO₂ lattice as a result of the annealing process. The resulting multi-doped material results in enhanced photocatalytic activity.

The dopant to be introduced into the TiO₂ lattice may be determined by selecting the appropriate organic acid to be used during the solubilising step. For example to achieve chlorine doping trichloroacetic acid may be used as the organic acid; to achieve fluorine doping trifluoroacetic acid may be used as the organic acid; to achieve fluorine doping tribromoroactic acid may be used as the organic acid; to achieve iodine doping triiodoacetic acid may be used as the organic acid; to achieve nitrogen doping cyanoacetic acid may be used as the organic acid; to achieve carbon doping formic acid, or acetic acid, or propanoic acid, or butanoic acid may be used as the organic acid; to achieve carbon/fluorine doping fluoroacetic acid, or difluoroacetic acid, or trifluoroacetic acid, or fluorinated formic acids, or fluorinated propanoic acids, or fluorinated butanoic acids may be used as the organic acid; to achieve carbon/chlorine doping chloroacetic acid, or dichloroacetic acid, or trichloracetic acids, or chlorinated formic acids, or chlorinated propanoic acids, or chlorinated butanoic acids may be used as the organic acid; to achieve carbon/bromine doping bromoacetic acetic acid, or dibromoacetic acid, or tribromoacetic acids, or brominated formic acids, or brominated propanoic acids, or brominated butanoic acids may be used as the organic acid; to achieve carbon/iodine doping iodoacetic acetic acid, or diiodomoacetic acid, or triiodoacetic acids, or iodinated formic acids, or brominated propanoic acids, or brominated butanoic acids may be used as the organic acid.

After annealing substantially all of the TiO₂ may be in rutile phase. Alternatively after annealing substantially all of the TiO₂ may be in anatase phase. Alternatively after annealing part of the TiO₂ may be in rutile phase and part of the TiO₂ may be in anatase phase. After annealing the sulfur dopant comprises a cationic dopant, the carbon dopant comprises a cationic dopant, and the fluorine dopant comprises an anionic dopant.

During the doping mechanism sulfur is introduced as a cation into the TiO₂ lattice, the titanium atom is substituted for a sulfur atom and the sulfur forms sulfur—oxygen bonds. Carbon doping of TiO₂ occurs in a similar manner. It is believed that a similar cationic substitution would occur with phosphorus. The doping of nitrogen, fluorine, chlorine, bromine and iodine into the TiO₂ lattice occurs by adding as anions. These elements substitute the oxygen atoms and form for example fluorine—titanium bonds. The process of the invention enables multi-doping of TiO₂ with a wide range of non-metal dopants in both anionic and cationic fashions.

An X-ray Photoelectron Spectroscopy (XPS) survey spectrum was carried out on the sulfur doped TiO₂ films annealed at 600° C. The XPS measures the elemental composition, empirical formula, chemical state and electronic state of the elements present in a sample. The spectra are obtained by irradiating a material with a beam of X-rays while simultaneously measuring for characteristic kinetic energy (KE) peaks for each element. FIG. 12 illustrates the presence of sulfur, fluorine and carbon doping of TiO₂ in the final multi-doped film. FIG. 12 illustrates the XPS spectra (a) sulfur (S 2p), (b) fluorine (F 1s) and (c) carbon (C 1s).

The S 2p spectra (see FIG. 12(a)) may be deconvoluted into two peaks—these appear as a doublet of 2p_{3/2} and 2p_{1/2}. The S 2p spectra shows a narrow peak is fitted with two component peaks to represent the doublet with an intensity ratio 2:1 and the characteristic doublet separation for S 2p. The binding energy suggests sulfur is present in a single +6 oxidation state and has entered the lattice as a cationic dopant replacing Ti⁴⁺ ions.

The F 1s spectra (see FIG. 12(b)) is composed of a single peak. The peak at a binding energy of 684.3 eV is characteristic of fluoride ions (F—) in the form of anionic Ti—F bonds in the TiO₂ lattice.

The C is spectra results (see FIG. 12(c)) indicate the main C is XPS peak (288.0 eV) may be assigned to a Ti—O—C structure in carbon-doped titania by substituting some of the lattice titanium atoms by cationic carbon. In addition, the smaller component at a binding energy of 289.1 eV may be attributed to O═C—O components.

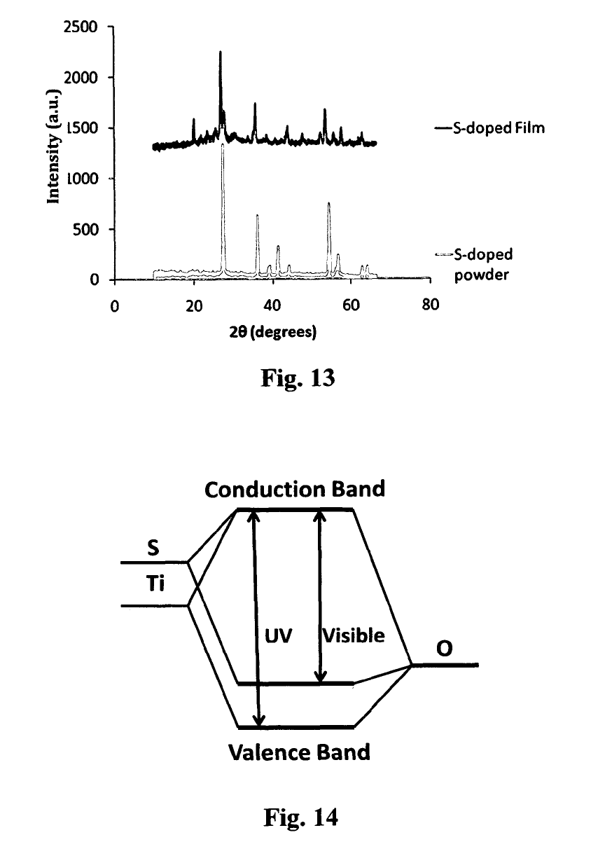

FIG. 13 illustrates the XRD patterns of the sulfur doped TiO₂ film applied to a ceramic tile and a sulfur doped TiO₂ powder heated to 800° C. FIG. 13 illustrates that the doped TiO₂ crystal structure is still maintained on the coated surface of the ceramic tile in comparison to doped TiO₂ powder. This indicates that the doped TiO₂ produced during the process described herein is not chemically modified due to deposition on to a surface or substrate, and that the functionality of the sulfur doped TiO₂ is maintained in film form. The bands have sharpened due to the crystal growth resulting from the annealing temperature of 800° C. and the additional minor bands are from the underlying clay. Further analysis by wavelength dispersive x-ray spectroscopy (WDS) revealed that the concentration of sulfur present in the sulfur doped TiO₂ films to be 0.25%.

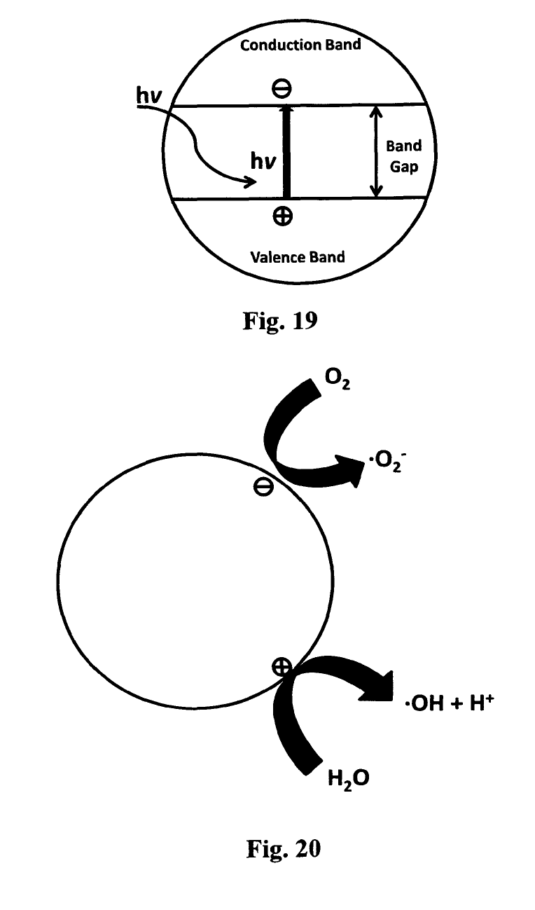

Titanium dioxide is a semi-conductor material with a wide band gap of 3.0 eV. The band gap therefore requires a photon of energy, with this amount energy (hv), to excite an electron from the valence shell through the band gap and into the conduction band. This promotion of the electron also generates a hole in the valence band, as illustrated in FIG. 19. FIG. 19 illustrates photoexcitation of an electron. The electron and hole migrate to the surface of the titanium dioxide particle catalyzing the reaction of an oxygen molecule to form a superoxide ion radical (.O₂⁻) as well as the transformation of a water molecule to form a hydroxyl radical (.OH), as illustrated in FIG. 20. These reactive oxygen species then react with organic material breaking them down into CO₂ and H₂O. FIG. 20 illustrates generation of reactive oxygen species. Titanium dioxide due to its wide band gap may only be activated by ultraviolet (UV) light. UV activation has many drawbacks. The increased functionality of the doped material of the invention is due to the doping of TiO₂ which creates an impurity energy level in the original band gap. This shortens the band gap allowing lower energy photons of visible light to activate the TiO₂ as illustrated in FIG. 14. This allows for the photoresponse of TiO₂ by visible light as illustrated in FIG. 14. FIG. 14 illustrates the doping of the TiO₂ with sulfur.

The material of the invention may be activated by visible light. Because of the band gap of the material of the invention, this enables a greater percentage of the radiant solar energy available to be utilised in comparison to absorption of UV light with a wavelength less than 380 nm.

The doped TiO₂ material of the invention reduces the band gap of TiO₂ thus allowing photoactivition by visible light. The band gap of TiO₂ is reduced so that lower energy photons from higher wavelengths, in this case visible light with a wavelength greater than 380 nm, may cause activation. The material of the invention may thus enjoy increased functionality. The material of the invention allows photo activation of TiO₂ by normal incandescent/fluorescent indoor lighting giving the surface antibacterial, anti-pollution/odour, self-cleaning properties. Fluorescent and incandescent indoor lighting emit minimal UV light. Outdoors the material of the invention utilizes a far greater amount of the radiant solar energy giving a greater performance level than conventional materials.

The multi doping of TiO₂ may be a two step process involving an initial doping of the soluble TiO₂ with a non-metal, such as sulphur:

TiO₂/TFA+S→S/TiO₂/TFA

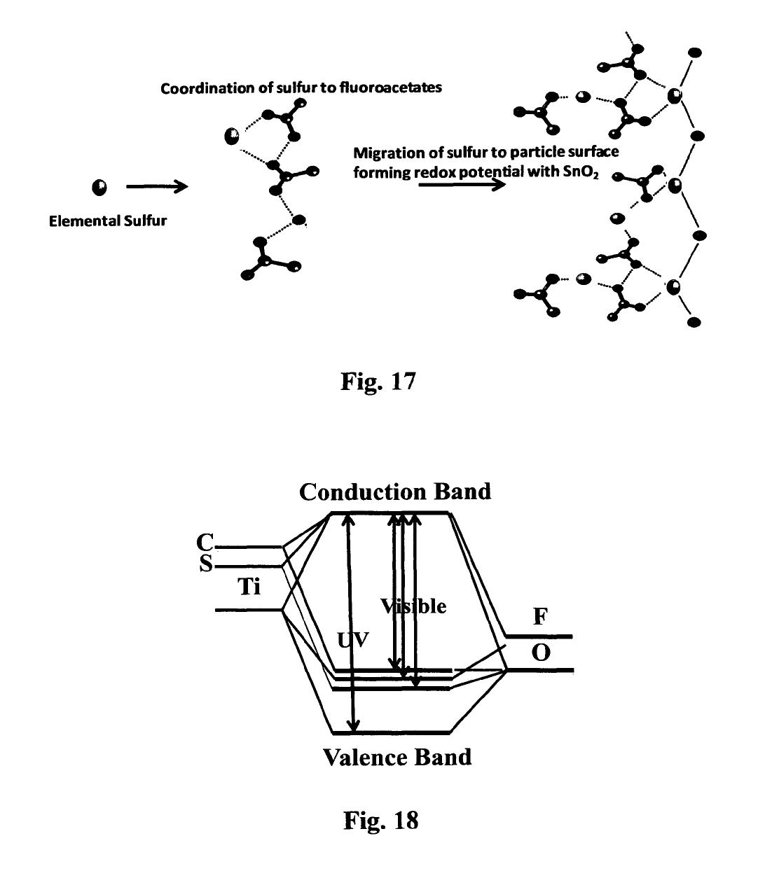

The mechanism of doping occurs due to the trifluoroacetate groups, coordinated to the TiO₂ particle, acting as a secondary coordination species to the sulphur, as illustrated in FIG. 17. The sulfur migrates to the surface of the TiO₂ particle where the redox potential generated introduces or ‘dopes’ the sulfur into the TiO₂ crystal lattice. FIG. 17 illustrates the sulfur doping mechanism.

The increased functionality of the doped material is due to this doping of TiO₂. The doping of sulfur creates an impurity energy level in the original band gap. This in effect shortens the band gap allowing lower energy photons of visible light to activate the TiO₂, as illustrated in FIG. 14. FIG. 14 illustrates the doping of TiO₂ with sulfur.

The second doping step to form multi doped TiO₂ occurs during annealing to the substrate. The thermal decomposition of the surface trifluoroacetate complexes leads to the migration of carbon and fluorine atoms into the TiO₂ lattice and the substitution of carbon and fluorine for oxygen and titanium respectively.

In comparison to doping with single non-metals, doping with the appropriate combination of dopants results in a more visible light sensitive TiO₂. It therefore increases the promotion of electron-hole separation and subsequently enhances the photoactivity, as illustrated in FIG. 18. FIG. 18 illustrates the multi-doping of TiO₂.

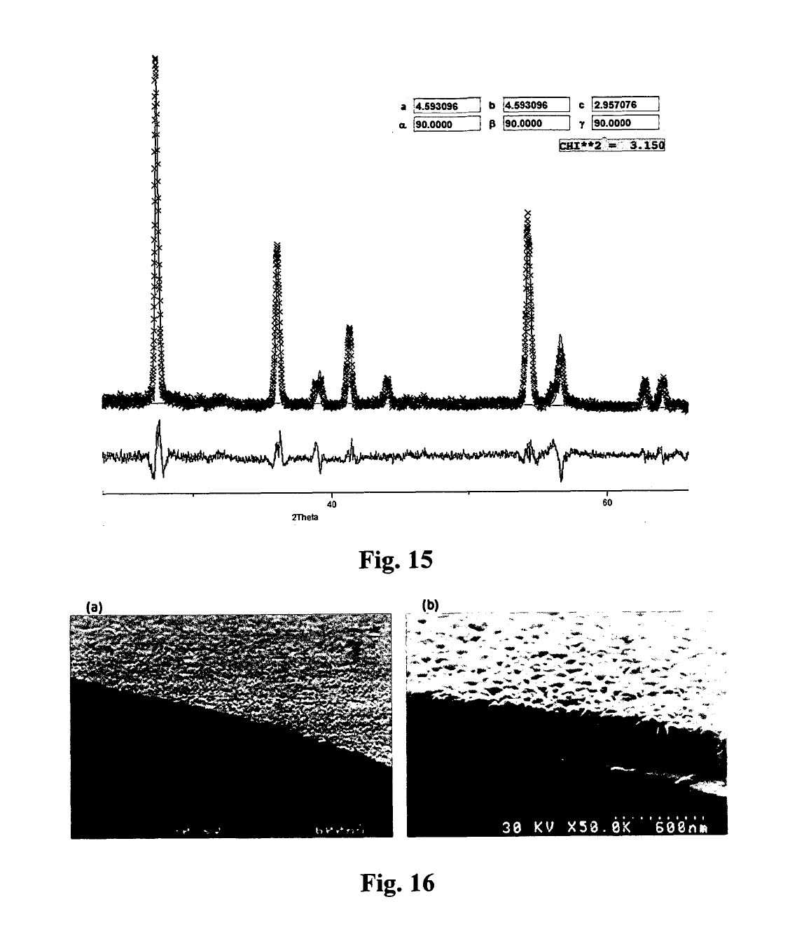

The process of preparation of the particles and the sol-gel method of deposition of the material onto a surface lead to the crystals growing in a lateral manner. The lateral growth of the material forming the film reduces cracking and delaminating while also contributing to the homogeny. The preferred lateral growth orientation is evident from X-ray Diffraction (XRD) analysis illustrated in FIG. 15 as the unit cell parameters deviate from those common to rutile TiO₂ or to anatase TiO₂. FIG. 15 illustrates the XRD analysis of the multidoped TiO₂ material.

The production of smooth, uniform films due to the reduced particle size and the lateral growth of the particles is illustrated in FIG. 16. The films produced by the solubilising process of the invention have a number of significant physical advantages in comparison to other film production processes. FIG. 16(a) illustrates a film produced by the solubilising process of the invention, and FIG. 16(b) illustrates a film produced by another film production process. FIG. 16(b) illustrates the columnar nature of a film produced by another film production process which is in contrast with that found in a film produced by the solubilising process of the invention where lateral growth is evident ensuring the smooth features of the film. Surface roughness would diffract light reducing the transparency and affecting the visual quality of an underlying surface such as a ceramic tile or substrate. The enhanced smoothness and uniformity of the material of the invention increases the clarity of the film and maintains the aesthetic quality of the underlying surface such as a ceramic tile or substrate.

As a consequence of the ultra small particle size, very smooth, uniform films of S-doped TiO₂ may be produced as illustrated in FIG. 16. The added smoothness and uniformity increases the clarity of the film resulting in no decrease in the aesthetic quality of the underlying ceramic tile, or substrate or the like. A film with surface roughness would diffract light reducing the transparency and affecting the visual quality of the underlying ceramic tile, or substrate or the like.

The smoothness of the films obtained by means of the invention is illustrated further in FIG. 22. Atomic Force Microscopy (AFM) was carried out on similar ceramic tiles both coated and uncoated. The Atomic Force Microscopy (AFM) analysis measures the surface roughness factor. The S/TiO₂/TFA coated tile on the left in FIG. 22 is far smoother in nature with no large conglomerates on the surface in comparison to the uncoated tile on the right in FIG. 22. In fact the average surface roughness factor (Ra) for the coated tile is 13.9 nm while for the uncoated tile the Ra is 90.66 nm as measured by Spmlabs. The pores visible on the coated tile increase the surface area of the titanium dioxide which increases the potential activity of the film without affecting the overall smoothness of the film. This characteristic smoothness allows for greater transparency due to reduction of light diffraction.

The material of the invention is soluble, and does not need any additives such as surfactant/coupling agent/pH buffer to ensure stability of the material when mixed with a solvent. The isolated material retains its solubility. Solubility is achieved through a combination of the organic acid employed and the small particle size of the material. The small particle size allows the material to be soluble and the organic acid dictates which solvents the material it will be soluble in.

The invention enables soluble metal oxides to be produced resulting in homogenous solutions in common solvents without the need for additives, such as dispersants, for stability. The reduction of particle size growth during synthesis and the coordination of organic acids is utilised to generate these solutions.

The invention has a number of advantages, for example the necessity to add chemical dispersants to ensure the stability of the solution are not required. Therefore the solubilisation is a simple one step process with reduced cost. The presence of additives during formation of the film at the annealing stage may lead to chemical impurities that could be incorporated into the film. These impurities could have a detrimental effect on the functionality of the films.

Trifluoroacetic acid, a solubilising organic acid employed, coordinates to the titanium dioxide particle in a number of ways via hydrogen bonding, monodentate, bidentate etc bonding species. This is confirmed by infra-red spectroscopic analysis.

The small particle size allows the metal oxide to become soluble but it is the organic acid that dictates which solvents the metal oxide is soluble in, as illustrated in the following table. Different organic acids display completely different patterns in solubility due to a combination of varying electronegativity, acidity, dipole moment etc.

The following table illustrates the solubility of Titanium Dioxide/Trifluoroacetic acid

| Solvent | TiO₂/Trifluoroacetic Acid |
|---|---|
| Water | Positive |
| Methanol | Negative |
| Ethanol | Negative |
| Acetone | Positive |
| DMSO | Negative |
| Ether | Negative |
| DMF | Negative |
| Ethyl Acetate | Positive |
| Acetic Acid | Positive |
| THF | Positive |
| Acetonitrile | Negative |

The process of the invention for producing soluble TiO₂ has a number of advantages. It is not necessary to add chemical dispersants to ensure the stability of the solution. Therefore the solubilisation is a simple one step process with reduced cost. During formation of the film at the annealing stage, chemical impurities that are present could be incorporated into the film. These impurities may have a detrimental effect on the functionality of the films.

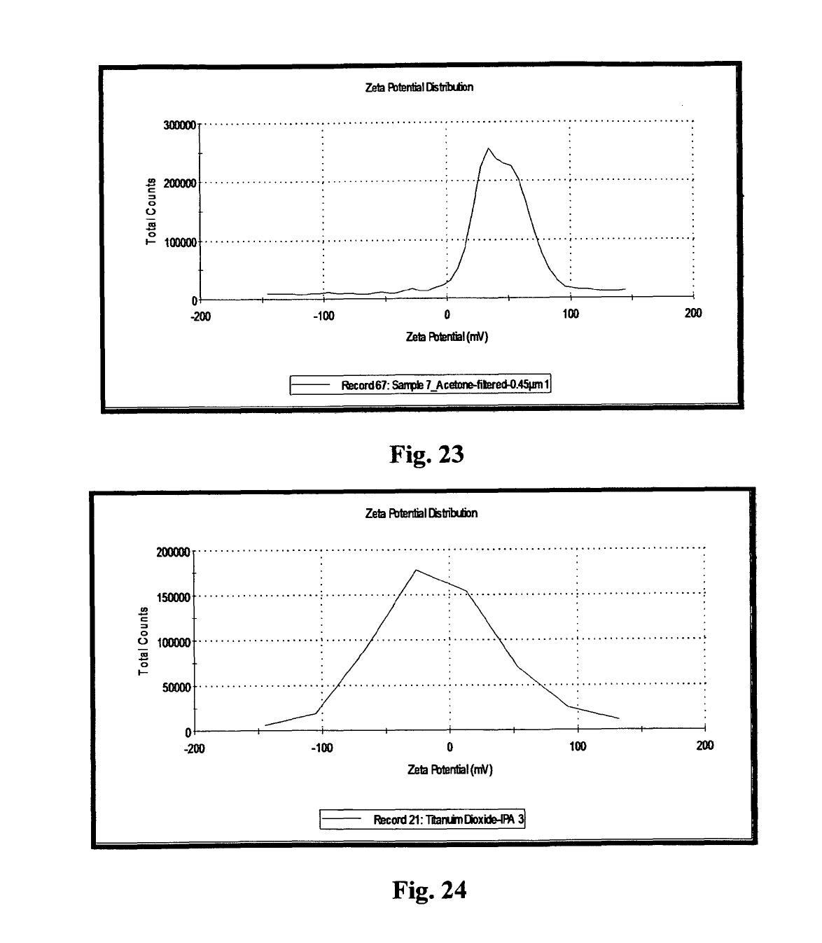

FIGS. 23 and 24 illustrate the zeta potential and particle size of the material of the invention. Measuring the zeta potential of a solution determines the stability of dispersed particles. It is the electrokinetic potential difference between the medium and the layer of fluid attached to the dispersed particle. The potential indicates the level of repulsion between adjacent particles in solution. Solutions with a high potential, either positive or negative, are electrically stabilized as repulsion is high and aggregation of particles is unfavoured. Solutions with a zeta potential greater than ±40 have good stability.

The zeta potential of the S/TiO₂/TFA material in acetone and isopropyl alcohol was measured and was found to be 45 and 54.5 mV (see FIGS. 23 and 24).

In combination to the zeta potential analysis, the particle size of the S/TiO₂/TFA material in solution was examined. Reduced particle size is of critical importance to ensure optimal smoothness of the film and dictates the stability of the solution. Size measurements were carried out with glass UV transparent cells and calibration with standard latex particles. The particle size of the material in isopropyl alcohol and acetone were measured, as follows:

| Solvent | Particle size (nm) of S/TiO₂/TFA |
|---|---|
| Isopropyl Alcohol | 4.62 ± 1.04 |
| Acetone | 8.25 ± 1.13 |

The average particle size in isopropyl alcohol and acetone was 4.62±1.04 and 8.25±1.13 respectively. The results indicate that the particles are in a stable soluble state in solution and the <10 nm size range will produce films with excellent smoothness and physical properties.

The doped photocatalytic material may be used in a variety of applications. For example the material may be used as part of a coating layer for coating at least part of a surface of a structural component, such as at least part of a surface of a tile element, and/or at least part of a surface of a steel element, and/or at least part of a surface of a polymeric element, and/or at least part of a surface of a glass element, and/or at least part of a surface of a silica element, and/or at least part of a surface of a zeolite element, and/or at least part of a surface of a stainless steel element, or used as part of grout for grouting a cavity, and/or as part of paint for painting a surface, and/or as part of cement as a binding agent. For example the material may be used as a photocatalyst for degrading organic matter, such as microbiological matter, and/or for reducing the concentration of pollutant gases, and/or for inhibiting formation of pollutant gases.

The sulfur doped TiO₂/TFA material may be modified and added to grouting adhesive or to a glaze to give an integrated photocatalytic product displaying biocidial and antipollution functionality.

The sulfur doped TiO₂/TFA material may first be heated to 600° C. for 5 hours to remove the surface coordinated trifluoroacetate groups producing sulfur doped TiO₂. The removal of the trifluoroacetate groups may be necessary as it may affect the integration into the base material for example a glaze or an adhesive. The heated material is left to cool and is ground with a mortar and pestle. The ground sulfur doped TiO₂ may then be added as a constituent of the glaze and dispersed by a homogeniser or to grouting adhesive and ground together with a mortar and pestle. The amount of sulfur doped TiO₂ powder added to the adhesive/glaze requires the base material to be rendered photocatalytic but without reducing the aesthetic of the glaze or the functionality of the grouting adhesive.

In the embodiment of the invention described above, the material comprises three dopants with each dopant being a non-metal. However it will be appreciated that the material may comprise two or more dopants with at least one of the dopants being a non-metal and with at least one of the dopants being a metal.

In the embodiment of the invention described above, the three non-metal dopants are added to the refluxed mixture of the TiO₂ and the organic acid to form a doped product before annealing the doped product. However it will be appreciated that in an alternative embodiment, one or more metal dopants may be added to the refluxed mixture of the TiO₂ and the organic acid to form a doped product before annealing the doped product. One or more non-metal dopants may then be added to the metal doped TiO₂ during the step of annealing the doped product. During annealing the heating process sinters the particles together to form a homogenous film. The annealing leads to multi-doping of the already metal doped TiO₂. This is due to the thermal decomposition of the surface trifluoroacetate groups and migration of the non-metal atoms, such as carbon and fluorine, into the TiO₂ lattice.

The invention is not limited to the embodiment hereinbefore described, with reference to the accompanying drawings, which may be varied in construction and detail.

1-146. (canceled)

147. A photocatalytic doped material having a crystalline atomic structure comprising
TiO₂;
and two or more dopants;
at least one of the dopants being a non-metal,
the material being soluble to facilitate dissolving of the material in a polar solvent to form a true solution without any dispersants.

148. A material as claimed in claim 147 wherein substantially all of the TiO₂ is in rutile phase.

149. A material as claimed in claim 147 wherein substantially all of the TiO₂ is in anatase phase.

150. A material as claimed in claim 147 wherein the non-metal dopant is selected from the group comprising sulfur, carbon, nitrogen, phosphorus, fluorine, chlorine, bromine, iodine, selenium, and astatine.

151. A material as claimed in claim 147 wherein the non-metal dopant comprises an anionic or cationic dopant.

152. A material as claimed in claim 147 wherein the material comprises at least two non-metal dopants preferably the material comprises at least three non-metal dopants.

153. A material as claimed in claim 152 wherein the first non-metal dopant comprises sulfur, the second non-metal dopant comprises fluorine, and the third non-metal dopant comprises carbon.

154. A material as claimed in claim 147 wherein the molar ratio of the TiO₂ to the non-metal dopant is in the range of from 99.9:0.1 to 97.5:2.5.

155. A material as claimed in claim 154 wherein the non-metal dopant comprises sulfur, and the molar ratio of the TiO₂ to the non-metal dopant is in the range of from 99.9:0.1 to 98.5:1.5, preferably the molar ratio of the TiO₂ to the non-metal dopant is approximately 99.75:0.25.

156. A material as claimed in claim 154 wherein the non-metal dopant comprises carbon, and the molar ratio of the TiO₂ to the non-metal dopant is in the range of from 99.5:0.5 to 97.5:2.5 preferably the molar ratio of the TiO₂ to the non-metal dopant is approximately 98.7:1.3.

157. A material as claimed in claim 154 wherein the non-metal dopant comprises fluorine, and the molar ratio of the TiO₂ to the non-metal dopant is in the range of from 99.5:0.5 to 98:2 preferably the molar ratio of the TiO₂ to the non-metal dopant is approximately 99.1:0.9.

158. A material as claimed in claim 147 wherein at least one of the dopants is a metal.

159. A material as claimed in claim 147 wherein the material is soluble to facilitate dissolving of the material in a solvent selected from the group comprising water, acetone, trifluoroacetic acid, ethyl acetate, 3-propanone, glacial acetic acid, tetrahydrofuran, isopropyl alcohol, t-butanol, methoxy-2-propanol, hydroxy-4-methyl-pentanone, and acetic acid.

160. A material as claimed in claim 147 wherein the material has a lateral growth crystalline atomic structure and/or a transparent crystalline atomic structure.

161. A material as claimed in claim 147 wherein the crystallite particle size is in the range of from 0.75 nm to 1.75 nm, preferably approximately 1 nm.

162. A material as claimed in claim 147 wherein the material is photocatalytically active upon activation by visible light preferably upon activation by visible light having a wavelength in the range of from 380 nm to 780 nm.

163. A material as claimed in claim 147 wherein the material degrades organic matter and/or microbiological matter upon activation by visible light.

164. A material as claimed in claim 147 wherein the material generates any one or more of reactive oxygen species, hydroxyl radicals and/or superoxide ions upon activation by visible light.

165. A material as claimed in claim 147 wherein the material reduces the concentration of pollutant gases selected from the group comprising nitrogen oxides, sulphur oxides, carbon oxides, ammonia, volatile organic carbons, and tobacco smoke upon activation by visible light.

166. A material as claimed in claim 147 wherein the material inhibits formation of pollutant gases selected from the group comprising nitrogen oxides, sulphur oxides, carbon oxides, ammonia, volatile organic carbons, and tobacco smoke upon activation by visible light.

167. A material as claimed in claim 147 wherein the material becomes superhydrophilic upon activation by visible light.

168. A structural component comprising a doped material as claimed in claim 147.

169. A structural component as claimed in claim 168 wherein the structural component comprises a coating layer, the coating layer comprising a doped material.

170. A structural component as claimed in claim 169 wherein the contact angle defined between a droplet of a liquid resting upon the surface of the coating layer and the surface of the coating layer is less than 25°, preferably less than 10°, most preferably less than 5°.

171. A structural component as claimed in claim 169 wherein the structural component comprises any one or more of at least part of a tile element, at least part of a steel element, at least part of a polymeric element, at least part of a glass element, at least part of a silica element, and/or at least part of a zeolite element.

172. A structural component as claimed in claim 168 wherein the structural component comprises grout, and/or paint, and/or cement.

173. Use of a doped material as claimed in claim 147 for coating a surface selected from any one or more of a surface of a tile element, a surface of a steel element, a surface of a polymeric element, a glass element, a surface of a silica element, and/or a surface of a zeolite element.

174. Use of a doped material as claimed in claim 147 for grouting a cavity, and/or for painting a surface, and/or as a binding agent.

175. Use of a doped material as claimed in claim 147 as any one or more of a catalyst, a photocatalyst, degrading organic matter, degrading microbiological matter, reducing the concentration of pollutant gases and/or inhibiting formation of pollutant gases.

176. A photocatalytic material having a crystalline atomic structure comprising TiO₂, the material being photocatalytically active upon activation by visible light, the material being soluble to facilitate dissolving of the material in a polar solvent to form a true solution without any dispersants.

177. A material as claimed in claim 176 wherein substantially all of the TiO₂ is in rutile phase.

178. A material as claimed in claim 176 wherein substantially all of the TiO₂ is in anatase phase.

179. A material as claimed in claim 176 wherein the material is photocatalytically active upon activation by visible light having a wavelength in the range of from 380 nm to 780 nm.

180. A material as claimed in claim 176 wherein the material degrades organic matter and/or microbiological matter upon activation by visible light.

181. A material as claimed in claim 176 wherein the material generates reactive oxygen species, hydroxyl radicals and/or superoxide ions upon activation by visible light.

182. A material as claimed in claim 176 wherein the material reduces the concentration of pollutant gases selected from the group comprising nitrogen oxides, sulphur oxides, carbon oxides, ammonia, volatile organic carbons, and tobacco smoke upon activation by visible light.

183. A material as claimed in claim 176 wherein the material inhibits formation of pollutant gases selected from the group comprising nitrogen oxides, sulphur oxides, carbon oxides, ammonia, volatile organic carbons, and tobacco smoke upon activation by visible light.

184. A material as claimed in claim 176 wherein the material becomes superhydrophilic upon activation by visible light.

185. A material as claimed in claim 176 wherein the material is soluble to facilitate dissolving of the material in a solvent selected from the group comprising water, acetone, trifluoroacetic acid, ethyl acetate, 3-propanone, glacial acetic acid, tetrahydrofuran, isopropyl alcohol, t-butanol, methoxy-2-propanol, hydroxy-4-methyl-pentanone, and acetic acid.

186. A material as claimed in claim 176 wherein the material has a lateral growth crystalline atomic structure and/or a transparent crystalline atomic structure.

187. A material as claimed in claim 176 wherein the crystallite particle size is in the range of from 0.75 nm to 1.75 nm preferably approximately 1 nm.

188. A material as claimed in claim 176 wherein the material is doped with one or more dopants.

189. A material as claimed in claim 188 wherein the dopant is a non-metal and/or a metal.

190. A material as claimed in claim 189 wherein the non-metal dopant is selected from the group comprising sulfur, carbon, nitrogen, phosphorus, fluorine, chlorine, bromine, iodine, selenium, and astatine.

191. A material as claimed in claim 189 wherein the dopant comprises an anionic dopant or a cationic dopant.

192. A material as claimed in claim 188 wherein the material comprises at least two dopants preferably at least three dopants.

193. A material as claimed in claim 192 wherein the first dopant comprises sulfur, the second dopant comprises fluorine, and the third dopant comprises carbon.

194. A material as claimed in claim 188 wherein the molar ratio of the TiO₂ to the dopant is in the range of from 99.9:0.1 to 97.5:2.5.

195. A material as claimed in claim 194 wherein the dopant comprises sulfur, and the molar ratio of the TiO₂ to the dopant is in the range of from 99.9:0.1 to 98.5:1.5 preferably approximately 99.75:0.25.

196. A material as claimed in claim 194 wherein the dopant comprises carbon, and the molar ratio of the TiO₂ to the dopant is in the range of from 99.5:0.5 to 97.5:2.5, preferably approximately 98.7:1.3.

197. A material as claimed in claim 194 wherein the dopant comprises fluorine, and the molar ratio of the TiO₂ to the dopant is in the range of from 99.5:0.5 to 98:2, preferably approximately 99.1:0.9.

198. A structural component comprising a photocatalytic material as claimed in claim 176.

199. A structural component as claimed in claim 198 wherein the structural component comprises a coating layer, the coating layer comprising a photocatalytic material.

200. A structural component as claimed in claim 199 wherein the contact angle defined between a droplet of a liquid resting upon the surface of the coating layer and the surface of the coating layer is less than 25°, preferably less than 10°, most preferably less than 5°.

201. A structural component as claimed in claim 198 wherein the structural component comprises at least part of a tile element, and/or at least part of a steel element, and/or at least part of a polymeric element.

202. A structural component as claimed in claim 198 wherein the structural component comprises any one or more of at least part of a glass element, at least part of a silica element, and/or at least part of a zeolite element.

203. A structural component as claimed in claim 198 wherein the structural component comprises grout, and/or paint, and/or cement.

204. Use of a photocatalytic material as claimed in claim 176 for coating a surface selected from any one or more of a surface of a tile element, a surface of a steel element, a surface of a polymeric element, coating a surface of a glass element, a surface of a silica element, and/or a surface of a zeolite element.

205. Use of a photocatalytic material as claimed in claim 176 for grouting a cavity, and/or for painting a surface, and/or as a binding agent.

206. Use of a photocatalytic material as claimed in claim 176 as a catalyst, a photocatalyst, for degrading organic matter, for degrading microbiological matter, for reducing the concentration of pollutant gases, and/or for inhibiting formation of pollutant gases.

207. A method of forming a doped material, the method comprising the steps of adding a non-metal dopant to TiO₂ to form a doped product, and annealing the doped product.

208. A method as claimed in claim 207 wherein the method comprises the step of forming the TiO₂ before adding the non-metal dopant.

209. A method as claimed in claim 208 wherein the step of forming the TiO₂ comprises the steps of; hydrolysis of a metal compound by adding the metal compound to an alcohol to form an hydrolysis product, neutralisation of the hydrolysis product comprising the step of adding the hydrolysis product to an alkali to form a neutralisation product, washing the neutralisation product and drying the neutralisation product to form hydrous TiO₂.

210. A method as claimed in claim 208 wherein the method comprises the step of solubilising the TiO₂ before adding the non-metal dopant.

211. A method as claimed in claim 210 wherein the TiO₂ is solubilised by adding the Ti02 to an organic acid selected from the group comprising trifluoroacetic acid, trichloroacetic acid, tribromoroactic acid, triiodoacetic acid, cyanoacetic acid, formic acid, acetic acid, propanoic acid, butanoic acid, fluoroacetic acid, difluoroacetic acid, fluorinated formic acid, fluorinated propanoic acid, fluorinated butanoic acid, chloroacetic acid, dichloroacetic acid, chlorinated formic acid, chlorinated propanoic acid, chlorinated butanoic acid, bromoacetic acetic acid, dibromoacetic acid, brominated formic acid, brominated propanoic acid, brominated butanoic acid, iodoacetic acetic acid, diiodomoacetic acid, and iodinated formic acid.

212. A method as claimed in claim 210 wherein the method comprises the step of refluxing the mixture of the TiO₂ and the organic acid.

213. A method as claimed in claim 207 wherein the non-metal dopant is added to the TiO₂ before annealing the doped product.

214. A method as claimed in claim 207 wherein the non-metal dopant is added in powder form to the TiO₂.

215. A method as claimed in claim 207 wherein the non-metal dopant is added to the TiO₂ during the step of annealing the doped product.

216. A method as claimed in claim 207 wherein the method comprises the step of adding a metal dopant to the TiO₂ before annealing the doped product.

217. A method as claimed in claim 207 wherein the non-metal dopant is selected from the group comprising sulfur, carbon, nitrogen, phosphorus, fluorine, chlorine, bromine, iodine, selenium, and astatine.

218. A method as claimed in claim 207 wherein at least two non-metal dopants are added to the TiO₂, preferably at least three non-metal dopants are added to the TiO₂.

219. A method as claimed in claim 218 wherein the first non-metal dopant comprises sulfur, the second non-metal dopant comprises fluorine, and the third non-metal dopant comprises carbon.

220. A method as claimed in claim 207 wherein the method comprises the steps of refluxing the doped product before annealing and applying the doped product to a surface before annealing.

221. A method as claimed in claim 220 wherein the doped product is applied to the surface by any one or more of dip coating, spray coating or spin coating.

222. A method as claimed in claim 207 wherein the doped product is annealed at a temperature in the range of from 500° C. to 1000° C., preferably approximately 600° C.

223. A method as claimed in claim 207 wherein substantially all of the TiO₂ is in rutile phase after annealing.

224. A method as claimed in claim 207 wherein substantially all of the TiO₂ is in anatase phase after annealing.

225. A method as claimed in claim 207 wherein the non-metal dopant comprises an anionic or cationic dopant after annealing.

226. A process of producing a multi-doped crystal structure with cationic and anionic dopants comprising the step of annealing between a temperature range of 500° C. to 1000° C.
